(19) United States
(12) Patent Application Publication
(10) Pub. No.: US 2018/0323928 A1
(43) Pub. Date: Nov. 8, 2018

(54) Sounding Reference Signal Design In Mobile Communications

(71) Applicant: MediaTek Inc., Hsinchu City (TW)

(72) Inventor: Weidong Yang, San Diego, CA (US)

(21) Appl. No.: 15/970,828

(22) Filed: May 3, 2018

Related U.S. Application Data
(60) Provisional application No. 62/502,555, filed on May 5, 2017.

(51) Int. Cl. H04L 5/00; H04W 72/04

(52) U.S. Cl. CPC H04L 5/0048; H04W 72/0453; H04L 5/001; H04J 2211/005; H04W 72/042

(57) ABSTRACT

Various solutions for sounding reference signal (SRS) design with respect to user equipment and network apparatus in mobile communications are described. An apparatus may receive a first SRS configuration. The apparatus may determine a first operating bandwidth part. The apparatus may further transmit a first SRS on the first operating bandwidth part according to the first SRS configuration. The first SRS configuration may correspond to the first operating bandwidth part.

### CROSS REFERENCE TO RELATED PATENT APPLICATION(S)

The present disclosure is part of a non-provisional application claiming the priority benefit of U.S. Patent Application No. 62/502,555, filed on 5 May 2017, the content of which is incorporated by reference in its entirety.

### TECHNICAL FIELD

The present disclosure is generally related to mobile communications and, more particularly, to sounding reference signal design with respect to user equipment and network apparatus in mobile communications.

### BACKGROUND

Unless otherwise indicated herein, approaches described in this section are not prior art to the claims listed below and are not admitted as prior art by inclusion in this section.

In the Long-Term Evolution (LTE), the sounding reference signal (SRS) is a type of reference signal and may be transmitted from a user equipment (UE) to a network apparatus. The SRS may be used to acquire uplink channel state information by the network side. The SRS transmission in the uplink may also be used to deduce the channel information in the downlink when channel reciprocity between downlink and uplink is held.

In the New Radio (NR) communication network or the newly developed next generation communication network, the SRS may also be used to facilitate cross link interference (CLI) mitigation. The SRS may be transmitted from a UE to a transmit/receive point (TRP) or from a UE to another UE. For CLI management, UE-UE measurement or TRP-TRP measurement may need to be performed and reported. To obtain UE-UE measurement, an additional or existing signal may be used for performing UE-UE measurement. Among uplink signals, the SRS may be considered for UE-UE CLI measurement. A first UE may be configured to transmit the SRS and a second UE may be configured to measure the SRS transmitted from the first UE.

Accordingly, the SRS transmission may become more complex and more flexible. How to properly transmit the SRS is an important issue in a communication network. The network apparatus may need to configure proper SRS resource set for each UE. The network apparatus may allocate specific radio resources in frequency domain and time domain for each UE to transmit the SRS. Therefore, in developing new communication systems, it is needed to properly design and define the configurations of the SRS.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to sounding reference signal design with respect to user equipment and network apparatus in mobile communications.

In one aspect, a method may involve an apparatus receiving a first sounding reference signal (SRS) configuration. The method may also involve the apparatus determining a first operating bandwidth part. The method may further involve the apparatus transmitting a first SRS on the first operating bandwidth part according to the first SRS configuration. The first SRS configuration may correspond to the first operating bandwidth part.

In one aspect, an apparatus may comprise a transceiver capable of wirelessly communicating with a plurality of nodes of a wireless network. The apparatus may also comprise a processor communicatively coupled to the transceiver. The processor may be capable of receiving a first sounding reference signal (SRS) configuration. The processor may also be capable of determining a first operating bandwidth part. The processor may further be capable of transmitting a first SRS on the first operating bandwidth part according to the first SRS configuration. The first SRS configuration may correspond to the first operating bandwidth part.

It is noteworthy that, although description provided herein may be in the context of certain radio access technologies, networks and network topologies such as LTE, LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sounding reference signal design with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

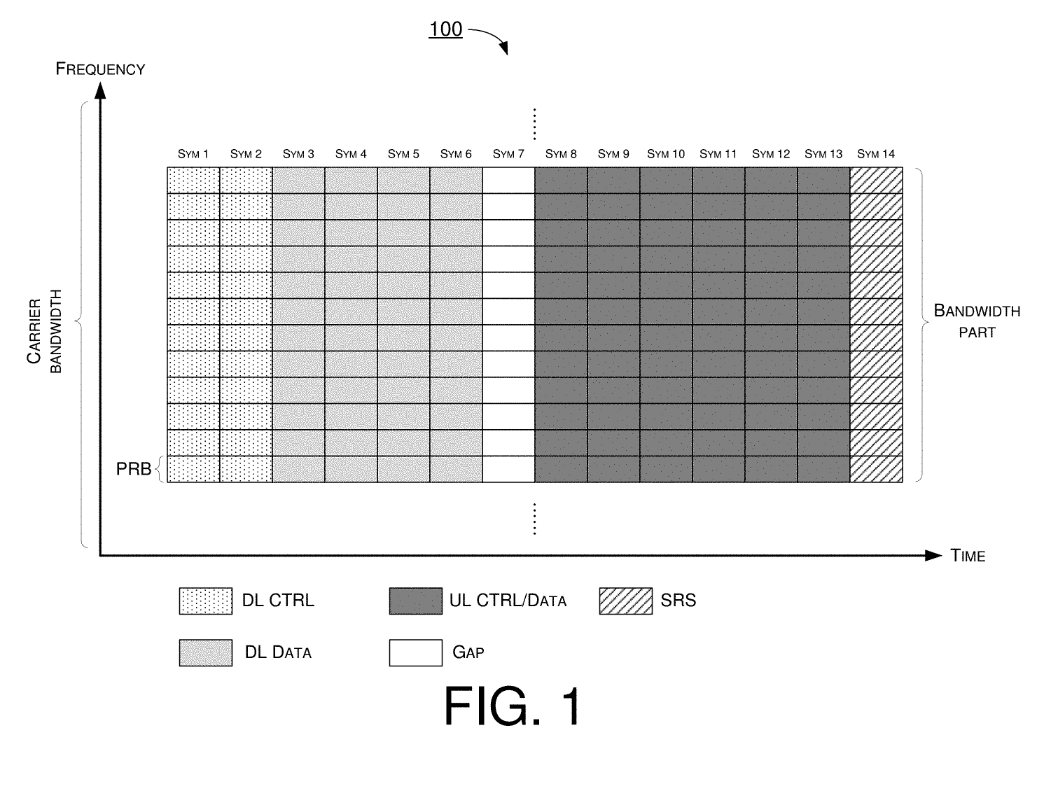

FIG. 1 illustrates an example scenario 100 under schemes in accordance with implementations of the present disclosure. Scenario 100 involves a user equipment (UE) and a network apparatus, which may be a part of a wireless communication network (e.g., an LTE network, an LTE-Advanced network, an LTE-Advanced Pro network, a 5G network, an NR network, an Internet of Things (IoT) network or a Narrow Band Internet of Things (NB-IoT) network). The network apparatus may be considered as a transmit/receive point (TRP) of the wireless communication network. The UE may be configured to transmit a sounding reference signal (SRS) to the network apparatus. The SRS is a type of reference signal for the network apparatus to estimate channel quality of uplink path for a frequency region. The SRS may be used to acquire uplink channel state information by the network side. After the uplink channel state information between the UE and the network is determined, frequency selective scheduling may be performed for uplink transmission for a single TRP reception or multiple TRP receptions.

In a time-division duplexing (TDD) system, the SRS transmission in the uplink may also be used to deduce the channel information in the downlink when channel reciprocity between downlink and uplink is held. Even in a case that only partial channel reciprocity is held, the downlink pre-coder may still be determined from the SRS reception. There may exist schemes whereby the full channel information may be acquired through hybrid channel state information (CSI) or through supplemental channel information feedback. For a frequency division duplexing (FDD) system, long term uplink channel information may also be proved to be useful in deriving downlink channel information.

On the other hands, the SRS may also be used to facilitate cross link interference (CLI) mitigation. Specifically, for CLI management, UE-UE measurement or TRP-TRP measurement may need to be performed and reported. To obtain UE-UE measurement, an additional or existing signal may be used for performing UE-UE measurement. Among uplink signals, the SRS may be considered for UE-UE CLI measurement. A first UE may be configured to transmit the SRS and a second UE may be configured to measure the SRS transmitted from the first UE.

The network apparatus may be configured to configure the SRS resource set for the UE. The network apparatus may allocate specific radio resources in frequency domain and time domain for the UE to transmit the SRS. For example, as showed in FIG. 1, there may be 14 orthogonal frequency-division multiplexing (OFDM) symbols in a slot. Symbols 1 and 2 may be configured for downlink control signal transmission. Symbols 3 to 6 may be configured for downlink data transmission. Symbol 7 may be a gap reserved for the UE to perform transmit/receive (Tx/Rx) or uplink/downlink transition. Symbols 8 to 13 may be configured for uplink control signal or uplink data transmission. Symbol 14 may be configured for SRS transmission. The network apparatus may configure a specific location in time domain (e.g., symbol 14) in a slot for the UE to transmit the SRS. The network apparatus may further configure a plurality of physical resource block (PRBs) in frequency domain for the UE to transmit/receive signals.

In a case that the UE transmits the SRS at symbol 14 in a slot, the other UEs may be configured to receive the transmitted SRS at symbol 14 and perform corresponding measurements. For the SRS transmission on a symbol, it may be possible to use a different subcarrier spacing for the SRS compared to other signals/channels (e.g., physical downlink shared channel (PDSCH)). In a case that the time duration of the SRS is less than one OFDM symbol at the reference numerology determined from PDSCH, there may be enough gaps around the SRS transmission allowing Tx/Rx switching at the sender and the recipient of the SRS. To allow UEs to take CLI measurements from each other, it may take multiple symbols or multiple slots for each UE to transmit the SRS and to take measurements of the transmitted SRS. This may be related to mutual hear ability problem in signal measurement and information exchange among peer nodes.

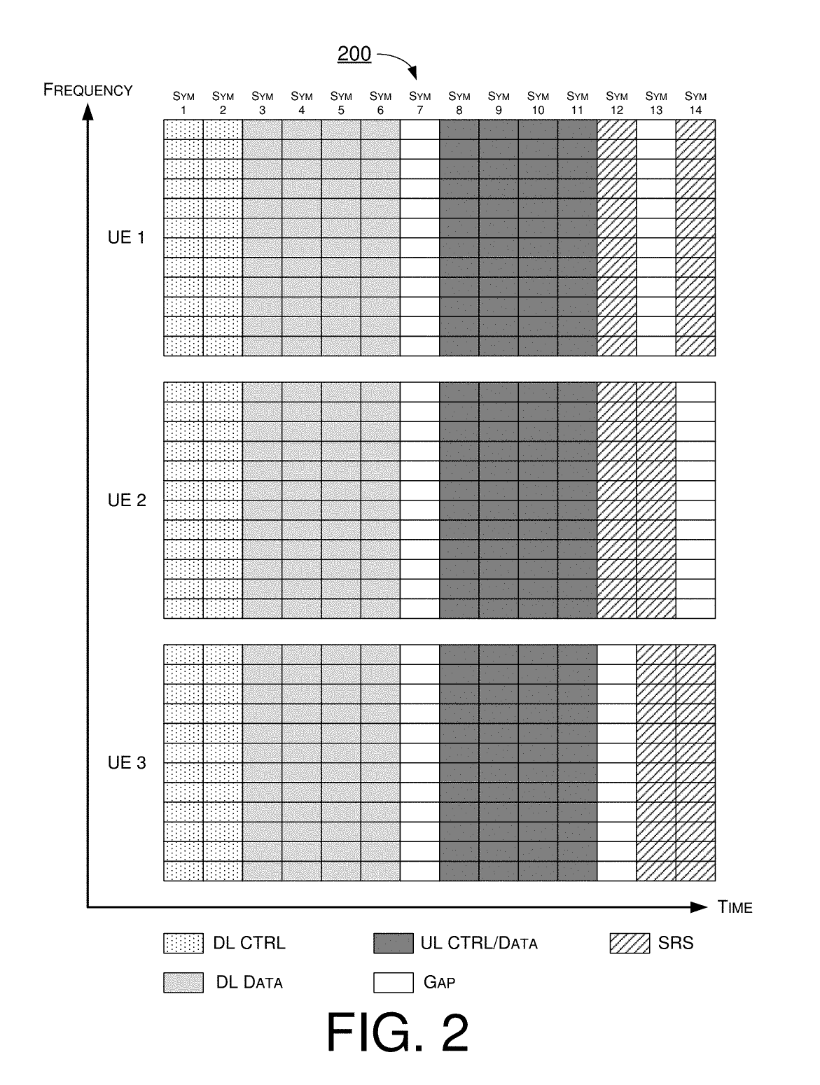

For the mutual hear ability problem, Tx/Rx patterns for the SRS may be configured by the network apparatus. One example is showed in FIG. 2. FIG. 2 illustrates an example scenario 200 under schemes in accordance with implementations of the present disclosure. Scenario 200 involves a plurality of UEs (e.g., UE 1, UE 2 and UE 3) and a plurality of network apparatus, which may be a part of a wireless communication network (e.g., an LTE network, an LTE-Advanced network, an LTE-Advanced Pro network, a 5G network, an NR network, an Internet of Things (IoT) network or a Narrow Band Internet of Things (NB-IoT) network). As showed in FIG. 2, UE 1 may be configured to transmit the SRS at symbol 12 and 14 and reserve a gap at symbol 13. UE 2 may be configured to transmit the SRS at symbol 12 and 13 and reserve a gap at symbol 14. UE 3 may be configured to transmit the SRS at symbol 13 and 14 and reserve a gap at symbol 12. In view of such configuration, UE 1 may be able to receive the SRS transmitted from UE 2 and UE 3 at symbol 13. UE 2 may be able to receive the SRS transmitted from UE 1 and UE 3 at symbol 14. UE 3 may be able to receive the SRS transmitted from UE 1 and UE 2 at symbol 12. As described above, the SRS may have a different subcarrier spacing and there may be enough gaps around the SRS to allow Tx/Rx switching. For example, at symbol 14, UE 1's SRS transmission may take only half of the OFDM symbol duration. Accordingly, for UE-UE CLI measurements, SRS transmissions may be configured at different locations in a slot. Similarly, SRS receptions may be configured at different locations in a slot.

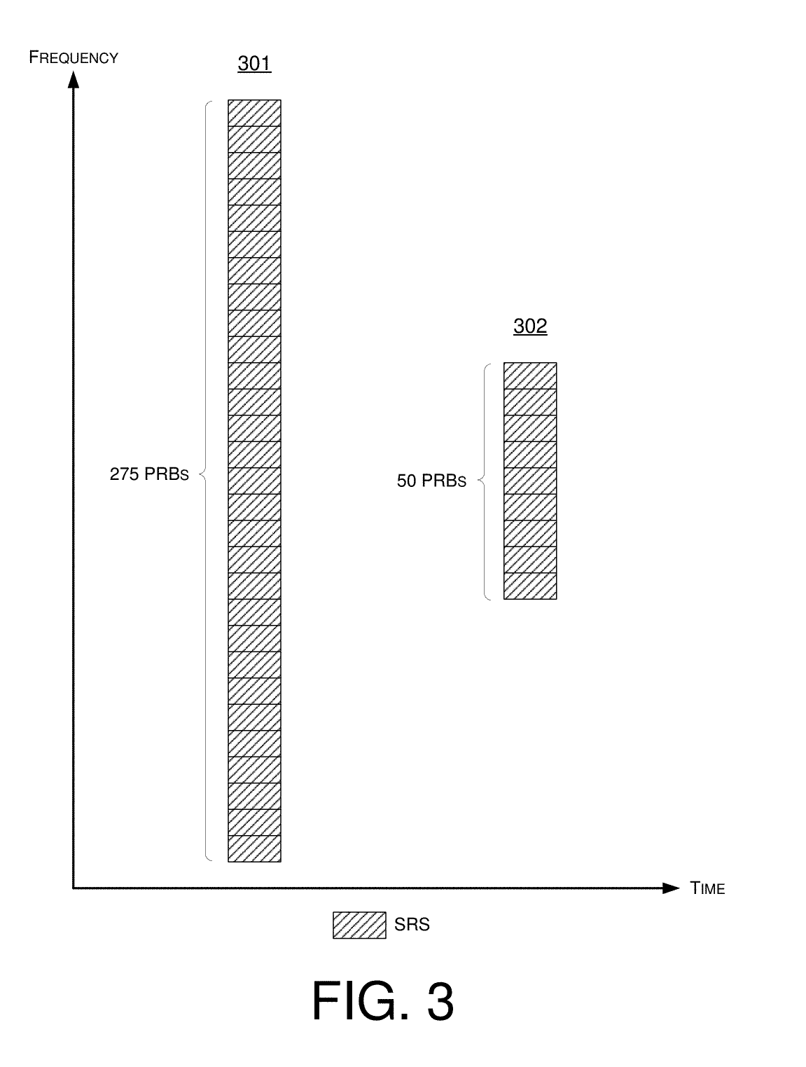

In some applications, the UE may be configured to support bandwidth adaption functionality. The operating bandwidth of the UE may be changed according to practical requirements (e.g., data throughput, available bandwidth or power consumption of the UE). Therefore, the SRS transmission may also need to be adapted according to UE's current operating bandwidth. FIG. 3 illustrates example scenarios 301 and 302 under schemes in accordance with implementations of the present disclosure. Scenarios 301 and 302 involve a UE and a network apparatus, which may be a part of a wireless communication network (e.g., an LTE network, an LTE-Advanced network, an LTE-Advanced Pro network, a 5G network, an NR network, an Internet of Things (IoT) network or a Narrow Band Internet of Things (NB-IoT) network). The UE may be configured at least one active component carrier (CC) with the network apparatus. There may be a plurality of carrier bandwidth parts (BWPs) within the active component carrier. A carrier bandwidth part may be a set of PRBs. The UE may be configured with multiple carrier bandwidth parts wherein at least one of them may be active.

In scenario 301, the UE may be configured to receive a first SRS configuration. The first SRS configuration may be received in a first radio resource control (RRC) configuration from the network apparatus. The first SRS configuration or the first RRC configuration may indicate a first bandwidth part in the frequency domain for transmitting a first SRS. The first bandwidth part may be a wideband operating bandwidth. For example, the first SRS configuration may indicate a first set of PRBs (e.g., 275 PRBs) for transmitting the first SRS. The UE may be configured to determine a first operating bandwidth part. The first operating bandwidth part may be an active bandwidth part within an active component carrier of the UE. The UE may be configured to perform signal transmission/reception in the first operating bandwidth part. Accordingly, the UE may be configured to transmit the first SRS on the first operating bandwidth part according to the first SRS configuration. The first SRS configuration may correspond to the first operating bandwidth part. For example, the first bandwidth part indicated by the first SRS configuration may be identical to the current operating bandwidth part.

In scenario 302, the UE may be configured to receive a second SRS configuration. The second SRS configuration may be received in a second RRC configuration from the network apparatus. The second RRC configuration may be different from the first RRC configuration. The second SRS configuration or the second RRC configuration may indicate a second bandwidth part in the frequency domain for transmitting a second SRS. The second bandwidth part may be different from the first bandwidth part. The second bandwidth part may be a partial band or a narrow band operating bandwidth. For example, the second SRS configuration may indicate a second set of PRBs (e.g., 50 PRBs) for transmitting the second SRS. The UE may be configured to determine a second operating bandwidth part. The second operating bandwidth part may be an active bandwidth part within an active component carrier of the UE. The UE may be configured to perform signal transmission/reception in the second operating bandwidth part. Accordingly, the UE may be configured to transmit the second SRS on the second operating bandwidth part according to the second SRS configuration. The second SRS configuration may correspond to the second operating bandwidth part. For example, the second bandwidth part indicated by the second SRS configuration may be identical to the current operating bandwidth part.

In some implementations, the UE may receive separate RRC configurations or SRS configurations for different operating bandwidth (e.g., wideband operating bandwidth and partial band operating bandwidth). The UE may receive a corresponding SRS configuration for each bandwidth part. The UE may be configured to determine a suitable SRS configuration according to UE's current operating bandwidth. For example, the UE may determine the first SRS configuration according to the first operating bandwidth part. The UE may determine the second SRS configuration according to the second operating bandwidth part. The UE should transmit the SRS on the current operating bandwidth part. In a case that the current operating bandwidth part is changed, the UE should also adjust the bandwidth part of SRS transmission.

In some implementations, the UE may receive an SRS configuration for wideband operating bandwidth. In a case that the current operating bandwidth is less than the configured wideband SRS configuration, the UE may be further configured to truncate the bandwidth part of the configured wideband SRS configuration to match with the current operating bandwidth part. For example, the configured wideband SRS configuration may indicate PRBs 1-200. In a case that the current operating bandwidth is over PRBs 51-100, only the SRS on PRBs 51-100 may be transmitted by the UE. The other parts of the SRS (e.g., SRS over PRBs 1-50 and PRBs 101-200) may be truncated and may not be transmitted by the UE.

### Illustrative Implementations

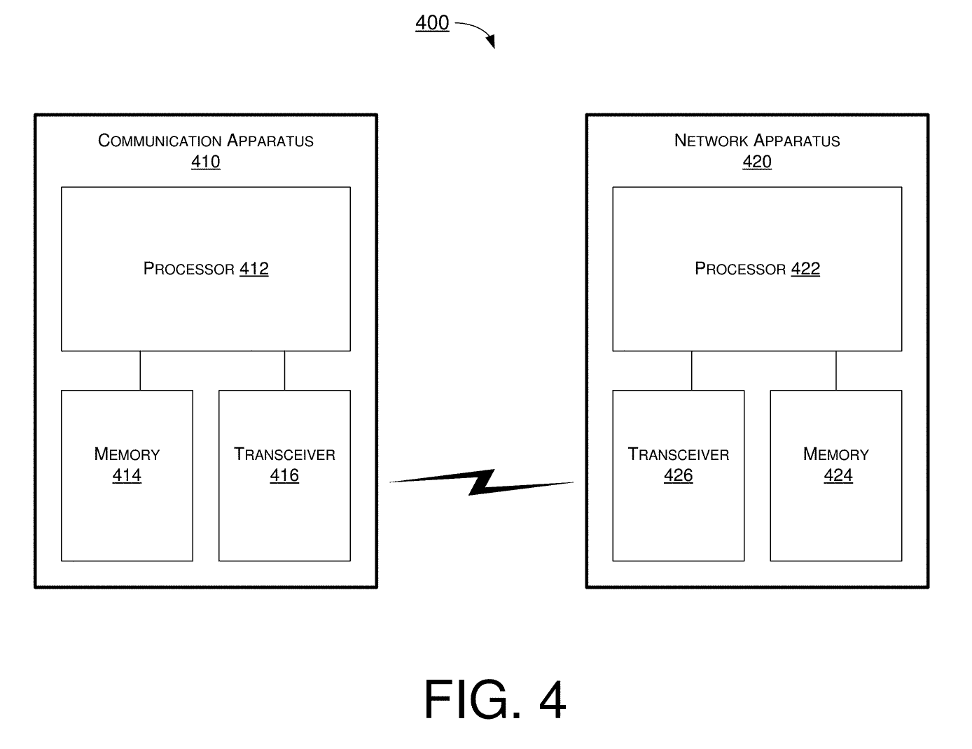

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to sounding reference signal design with respect to user equipment and network apparatus in wireless communications, including scenarios 100, 200, 301 and 302 described above as well as process 500 described below.

Communication apparatus 410 may be a part of an electronic apparatus, which may be a user equipment (UE) such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT or NB-IoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, or one or more complex-instruction-set-computing (CISC) processors. Communication apparatus 410 may include at least some of those components shown in FIG. 4 such as a processor 412, for example. communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a transmit/receive point (TRP), a base station, a small cell, a router or a gateway. For instance, network apparatus 420 may be implemented in an eNodeB in an LTE, LTE-Advanced or LTE-Advanced Pro network or in a gNB in a 5G, NR, IoT or NB-IoT network. Alternatively, network apparatus 420 may be implemented in the form of one or more IC chips such as, for example and without limitation, one or more single-core processors, one or more multi-core processors, or one or more CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 422 may be configured to configure the SRS resource set for communication apparatus 410. Processor 422 may allocate specific radio resources in frequency domain and time domain for communication apparatus 410 to transmit the SRS. For example, processor 422 may configure last symbol of a slot for communication apparatus 410 to perform SRS transmission. Processor 422 may further configure a plurality of physical resource block (PRBs) in frequency domain for communication apparatus 410 to transmit the SRS. Processor 422 may configure the SRS to have a different subcarrier spacing and there may be enough gaps around the SRS to allow Tx/Rx switching. For example, processor 412 may take only half of the OFDM symbol duration to perform the SRS transmission.

In some implementations, processor 422 may further configure Tx/Rx patterns for SRS transmissions and receptions. A first UE may be configured to transmit the SRS at a first symbol and a third symbol and reserve a gap at a second symbol. A second UE may be configured to transmit the SRS at the first symbol and the second symbol and reserve a gap at the third symbol. A third UE may be configured to transmit the SRS at the second symbol and the third symbol and reserve a gap at the first symbol. In such implementation, the first UE may be able to receive the SRS transmitted from the second UE and the third UE at the second symbol. The second UE may be able to receive the SRS transmitted from the first UE and the third UE at third symbol. The third UE may be able to receive the SRS transmitted from the first UE and the second UE at the first symbol. Accordingly, processor 422 may configure SRS transmissions at different locations in a slot. Processor 422 may also configure SRS receptions at different locations in a slot.

In some implementations, processor 412 may be configured to support bandwidth adaption functionality. The operating bandwidth of processor 412 or transceiver 413 may be changed according to practical requirements (e.g., data throughput, available bandwidth or power consumption). Processor 412 may be configured at least one active component carrier (CC) with network apparatus 420. There may be a plurality of carrier bandwidth parts (BWPs) within the active component carrier. A carrier bandwidth part may be a set of PRBs. Processor 412 may be configured with multiple carrier bandwidth parts wherein at least one of them may be active.

In some implementations, processor 412 may be configured to receive, via transceiver 416, a first SRS configuration. Processor 412 may receive the first SRS configuration in a first radio resource control (RRC) configuration from network apparatus 420. Processor 422 may use the first SRS configuration or the first RRC configuration to indicate a first bandwidth part in the frequency domain for transmitting a first SRS. The first bandwidth part may be a wideband operating bandwidth. For example, processor 422 may use the first SRS configuration to indicate a first set of PRBs (e.g., 275 PRBs) for transmitting the first SRS. Processor 412 may be configured to determine a first operating bandwidth part. The first operating bandwidth part may be an active bandwidth part within an active component carrier. Processor 412 may be configured to perform signal transmission/reception in the first operating bandwidth part. Accordingly, processor 412 may be configured to transmit the first SRS on the first operating bandwidth part according to the first SRS configuration. The first SRS configuration may correspond to the first operating bandwidth part. For example, the first bandwidth part indicated by the first SRS configuration may be identical to the current operating bandwidth part.

In some implementations, processor 412 may be configured to receive, via transceiver 416, a second SRS configuration. Processor 412 may receive the second SRS configuration in a second RRC configuration from the network apparatus. The second RRC configuration may be different from the first RRC configuration. Processor 422 may use the second SRS configuration or the second RRC configuration to indicate a second bandwidth part in the frequency domain for transmitting a second SRS. The second bandwidth part may be different from the first bandwidth part. The second bandwidth part may be a partial band or a narrow band operating bandwidth. For example, processor 422 may use the second SRS configuration to indicate a second set of PRBs (e.g., 50 PRBs) for transmitting the second SRS. Processor 412 may be configured to determine a second operating bandwidth part. The second operating bandwidth part may be an active bandwidth part within an active component carrier. Processor 412 may be configured to perform signal transmission/reception in the second operating bandwidth part. Accordingly, processor 412 may be configured to transmit the second SRS on the second operating bandwidth part according to the second SRS configuration. The second SRS configuration may correspond to the second operating bandwidth part. For example, the second bandwidth part indicated by the second SRS configuration may be identical to the current operating bandwidth part.

In some implementations, processor 412 may receive, via transceiver 416, separate RRC configurations or SRS configurations for different operating bandwidth (e.g., wideband operating bandwidth and partial band operating bandwidth). Processor 412 may receive a corresponding SRS configuration for each bandwidth part. Processor 412 may be configured to determine a suitable SRS configuration according to processor 412 or transceiver 416's current operating bandwidth. For example, processor 412 may determine the first SRS configuration according to the first operating bandwidth part. Processor 412 may determine the second SRS configuration according to the second operating bandwidth part. Processor 412 should transmit the SRS on the current operating bandwidth part. In a case that the current operating bandwidth part is changed, processor 412 should also adjust the bandwidth part of SRS transmission.

In some implementations, processor 412 may receive an SRS configuration for wideband operating bandwidth. In a case that the current operating bandwidth is less than the configured wideband SRS configuration, processor 412 may be further configured to truncate the bandwidth part of the configured wideband SRS configuration to match with the current operating bandwidth part. For example, the configured wideband SRS configuration may indicate PRBs 1-200. In a case that the current operating bandwidth is over PRBs 51-100, only the SRS on PRBs 51-100 may be transmitted by processor 412. The other parts of the SRS (e.g., SRS over PRBs 1-50 and PRBs 101-200) may be truncated and may not be transmitted by processor 412.

### Illustrative Processes

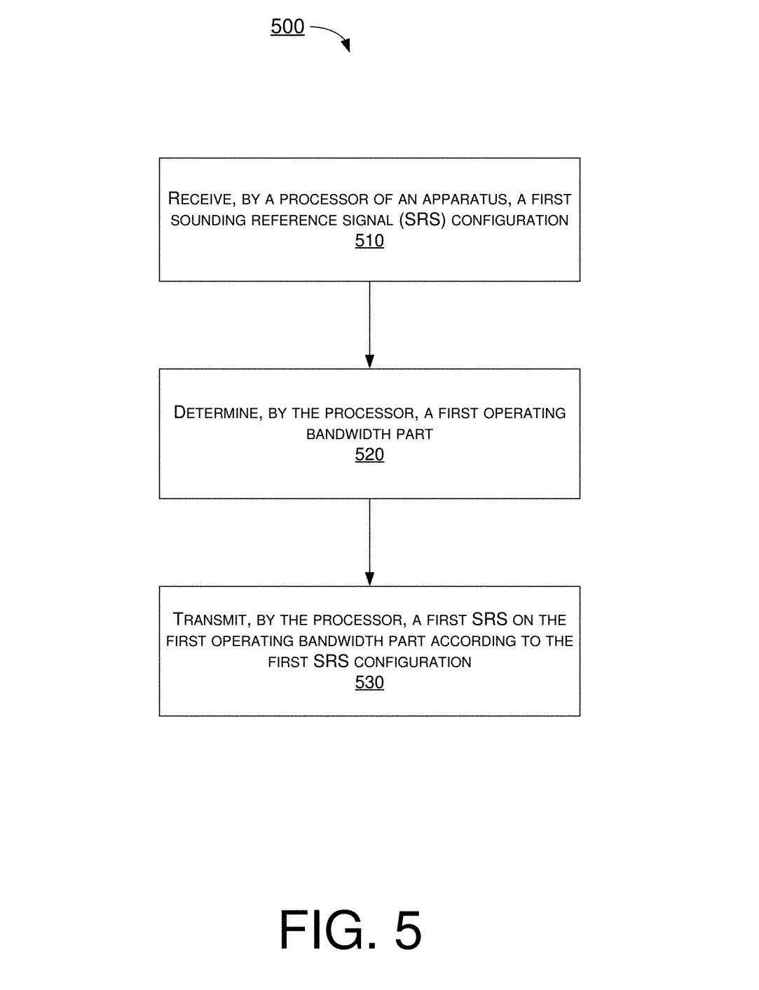

FIG. 5 illustrates an example process 500 in accordance with an implementation of the present disclosure. Process 500 may be an example implementation of scenarios 100, 200, 301 and 302, whether partially or completely, with respect to sounding reference signal design in accordance with the present disclosure. Process 500 may represent an aspect of implementation of features of communication apparatus 410. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At 510, process 500 may involve processor 412 of apparatus 410 receiving a first sounding reference signal (SRS) configuration. Process 500 may proceed from 510 to 520.

At 520, process 500 may involve processor 412 determining a first operating bandwidth part. Process 500 may proceed from 520 to 530.

At 530, process 500 may involve processor 412 transmitting a first SRS on the first operating bandwidth part according to the first SRS configuration. The first SRS configuration may correspond to the first operating bandwidth part.

In some implementations, process 500 may involve communication apparatus 410 receiving a second SRS configuration. Process 500 may also involve communication apparatus 410 determining a second operating bandwidth part. Process 500 may further involve communication apparatus 410 transmitting a second SRS on the second operating bandwidth part according to the second SRS configuration. The second SRS configuration may correspond to the second operating bandwidth part. The second operating bandwidth part may be different from the first operating bandwidth part.

In some implementations, the first SRS configuration and the second SRS configuration may be received in separate radio resource control (RRC) configurations.

In some implementations, the first SRS configuration may indicate the first operating bandwidth part. The second SRS configuration may indicate the second operating bandwidth part.

In some implementations, the first SRS configuration may indicate a first set of physical resource block (PRBs). The second SRS configuration may indicate a second set of PRBs.

In some implementations, at least one of the first operating bandwidth part and the second operating bandwidth part may comprise a wideband operating bandwidth.

In some implementations, at least one of the first operating bandwidth part and the second operating bandwidth part may comprise a partial band operating bandwidth.

In some implementations, at least one of the first operating bandwidth part and the second operating bandwidth part may comprise an active bandwidth part within an active component carrier.

In some implementations, process 500 may involve communication apparatus 410 determining the first SRS configuration according to the first operating bandwidth part. Process 500 may involve communication apparatus 410 determining the second SRS configuration according to the second operating bandwidth part.

In some implementations, process 500 may involve communication apparatus 410 truncating a bandwidth part of the first SRS configuration to match with the first operating bandwidth part when the first operating bandwidth part is less than the bandwidth part of the first SRS configuration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first sounding reference signal (SRS) configuration;
determining, by the processor, a first operating bandwidth part; and
transmitting, by the processor, a first SRS on the first operating bandwidth part according to the first SRS configuration,
wherein the first SRS configuration corresponds to the first operating bandwidth part.

2. The method of claim 1, further comprising:
receiving, by the processor, a second SRS configuration;
determining, by the processor, a second operating bandwidth part; and
transmitting, by the processor, a second SRS on the second operating bandwidth part according to the second SRS configuration,
wherein the second SRS configuration corresponds to the second operating bandwidth part, and wherein the second operating bandwidth part is different from the first operating bandwidth part.

3. The method of claim 2, wherein the first SRS configuration and the second SRS configuration are received in separate radio resource control (RRC) configurations.

4. The method of claim 2, wherein the first SRS configuration indicates the first operating bandwidth part, and wherein the second SRS configuration indicates the second operating bandwidth part.

5. The method of claim 2, wherein the first SRS configuration indicates a first set of physical resource block (PRBs), and wherein the second SRS configuration indicates a second set of PRBs.

6. The method of claim 2, wherein at least one of the first operating bandwidth part and the second operating bandwidth part comprises a wideband operating bandwidth.

7. The method of claim 2, wherein at least one of the first operating bandwidth part and the second operating bandwidth part comprises a partial band operating bandwidth.

8. The method of claim 2, wherein at least one of the first operating bandwidth part and the second operating bandwidth part comprises an active bandwidth part within an active component carrier.

9. The method of claim 2, further comprising:
determining, by the processor, the first SRS configuration according to the first operating bandwidth part; and
determining, by the processor, the second SRS configuration according to the second operating bandwidth part.

10. The method of claim 1, further comprising:
truncating, by the processor, a bandwidth part of the first SRS configuration to match with the first operating bandwidth part when the first operating bandwidth part is less than the bandwidth part of the first SRS configuration.

11. An apparatus, comprising:
a transceiver capable of wirelessly communicating with a plurality of nodes of a wireless network; and
a processor communicatively coupled to the transceiver, the processor capable of:
receiving, via the transceiver, a first sounding reference signal (SRS) configuration;
determining a first operating bandwidth part; and
transmitting, via the transceiver, a first SRS on the first operating bandwidth part according to the first SRS configuration,
wherein the first SRS configuration corresponds to the first operating bandwidth part.

12. The apparatus of claim 11, wherein the processor is further capable of:
receiving, via the transceiver, a second SRS configuration;
determining a second operating bandwidth part; and
transmitting, via the transceiver, a second SRS on the second operating bandwidth part according to the second SRS configuration,
wherein the second SRS configuration corresponds to the second operating bandwidth part, and wherein the first operating bandwidth part is different from the second operating bandwidth part.

13. The apparatus of claim 12, wherein the first SRS configuration and the second SRS configuration are received in separate radio resource control (RRC) configurations.

14. The apparatus of claim 12, wherein the first SRS configuration indicates the first operating bandwidth part, and wherein the second SRS configuration indicates the second operating bandwidth part.

15. The apparatus of claim 12, wherein the first SRS configuration indicates a first set of physical resource block (PRBs), and wherein the second SRS configuration indicates a second set of PRBs.

16. The apparatus of claim 12, wherein at least one of the first operating bandwidth part and the second operating bandwidth part comprises a wideband operating bandwidth.

17. The apparatus of claim 12, wherein at least one of the first operating bandwidth part and the second operating bandwidth part comprises a partial band operating bandwidth.

18. The apparatus of claim 12, wherein at least one of the first operating bandwidth part and the second operating bandwidth part comprises an active bandwidth part within an active component carrier.

19. The apparatus of claim 12, wherein the processor is further capable of:
determining the first SRS configuration according to the first operating bandwidth part; and
determining the second SRS configuration according to the second operating bandwidth part.

20. The apparatus of claim 11, wherein the processor is further capable of:
truncating a bandwidth part of the first SRS configuration to match with the first operating bandwidth part when the first operating bandwidth part is less than the bandwidth part of the first SRS configuration.
